(19) United States
(12) Patent Application Publication
(10) Pub. No.: US 2005/0076254 A1
(43) Pub. Date: Apr. 7, 2005

(54) Sleep recovery circuit and method

(76) Inventors: Michael A. Robinson, Femont, CA (US); Wei-Yung Chen, Sunnyvale, CA (US); Kenneth P. Sharp, Santa Clara, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/676,523

(22) Filed: Oct. 1, 2003

(51) Int. Cl. G06F 1/32

(52) U.S. Cl. 713/320; 713/300

(57) ABSTRACT

Systems and methods of recovering a device from a sleep mode of operation are described. In one aspect, a device includes a sleep recovery circuit that is operable to transition from a first signal detection mode to a second signal detection mode in response to detection of a first signal characteristic in an input signal. The sleep recovery circuit also is operable to transition from the second signal detection mode to a third operational mode in response to detection in the input signal of a second signal characteristic different from the first signal characteristic.

### TECHNICAL FIELD

This invention relates to systems and methods of recovering a device from a sleep mode of operation.

### BACKGROUND

Many different methods have been proposed for reducing power consumption in an electronic device (e.g., a portable electronic device or a computer system). In general, these methods typically involve shutting down one or more components of the electronic device. For example, in some approaches, one or more circuits of the electronic device are switched from a full-power (or wake) mode to a reduced power or sleep mode. In a sleep mode of operation, one or more circuits of the electronic device may be shut off by disconnecting these circuits from a power source. Alternatively, instead of disconnecting circuits from the power source, clock activity within one or more circuits may be suspended in a sleep mode of operation so that power consumption may be reduced significantly while preserving context information. In addition to wake and sleep modes, various other intermediate device modes of operation, which correspond to power consumption levels between the power consumption levels of the wake and sleep modes, have been proposed.

A device in a sleep mode of operation may exit, recover or awaken from the sleep mode in response to one or more wakeup events. Examples of wakeup events include: receipt of an external wakeup signal in a predetermined logic state; receipt of notification that a timing event has expired; receipt of an interrupt signal at an external pin; and receipt of a user-initiated signal. In many approaches, a sleep recovery circuit in an electronic device triggers a wakeup sequence for switching the electronic device from a sleep mode to a wake mode in response detection of at least one external event.

### SUMMARY

In one aspect of the invention, a device includes a sleep recovery circuit that is operable to transition from a first signal detection mode to a second signal detection mode in response to detection of a first signal characteristic in an input signal. The sleep recovery circuit also is operable to transition from the second signal detection mode to a third operational mode in response to detection in the input signal of a second signal characteristic different from the first signal characteristic.

In another aspect, the invention features a method of operating a device in which a first signal characteristic is detected in an input signal. The operational mode of the device is transitioned from a first signal detection mode to a second signal detection mode in response to detection of the first signal characteristic in the input signal. A second signal characteristic different from the first signal characteristic is detected in the input signal. The operational mode of the device is transitioned from the second signal detection mode to a third operational mode in response to detection of the second signal characteristic in the input signal.

Other features and advantages of the invention will become apparent from the following description, including the drawings and the claims.

### DESCRIPTION OF DRAWINGS

FIG. 1 is a block diagram of a sleep recovery circuit.

FIG. 2 is a flow diagram of a method of operating the sleep recovery circuit of FIG. 1.

FIG. 3 is a block diagram of an implementation of the sleep recovery circuit of FIG. 1.

FIG. 4 is a flow diagram of a method of operating the sleep recovery circuit of FIG. 3.

FIG. 5 is a flow diagram of an alternative method of operating the sleep recovery circuit of FIG. 3.

FIG. 6 is an exemplary application environment for the sleep recovery circuit of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

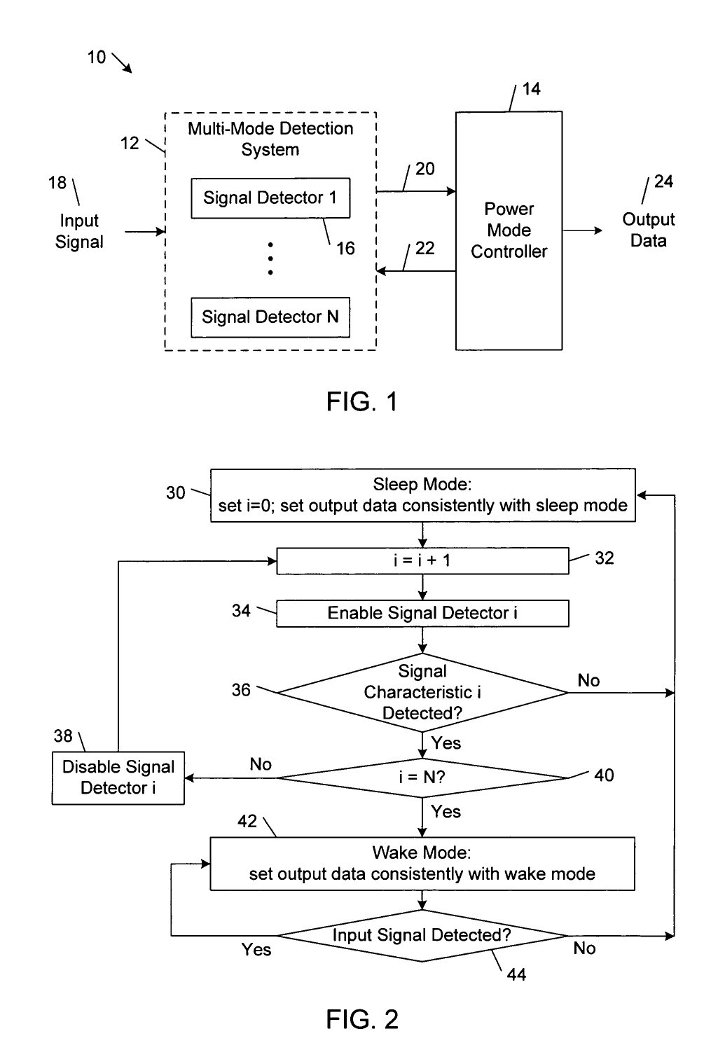

FIG. 1 shows an embodiment of a sleep recovery circuit 10 that includes a multi-mode detection system 12 and a power mode controller 14. The multi-mode detection system 12 includes N signal detectors 16, where N has an integer value of two or more. Each signal detector 16 is configured to detect a different respective characteristic of an input signal 18. The output signals 20 that are generated by the signal detectors 16 are transmitted to the power mode controller 14.

Based on the output signals 20 received from the signal detectors 16, the power mode controller 14 transitions from one signal detection mode to another. In general, the power mode controller 14 is operable to transition between a sleep mode and a wake mode. In some implementations, the power mode controller 14 transitions directly between the sleep mode and the wake mode. In other implementations, the power mode controller 14 transitions through one or more intermediate modes in the process of transitioning between the sleep mode and the wake mode. Power mode controller 14 transmits to the multi-mode detection system 12 control signals 22 for choreographing the operation of the signal detectors 16 during the various modes of operation. Power mode controller 14 also transmits to downstream device electronics output data 24 that varies depending on the current mode of operation. As used herein, the terms “mode of operation” and “operational mode” both refer broadly to any state of operation of the sleep recovery circuit 10 that is distinguishable from other states of operation on the basis of power consumption level. Exemplary operational modes include a sleep (or relatively low power) operational mode, a wake (or relatively high power) operational mode, and intermediate operational modes with respective power consumption levels between the wake operational mode and the sleep operational mode. Power mode controller 14 is not limited to any particular hardware or software configuration, but rather it may be implemented in any computing or processing environment, including in digital electronic circuitry or in computer hardware, firmware, or software.

As explained in detail below, in some implementations, the power mode controller 14 is configured to selectively enable the various signal detectors 16 of the multi-mode detection system 12 to accurately detect the presence of an actual input data signal, while achieving a lower overall power consumption than single-detector-based sleep recovery circuit designs providing similar detection accuracy. In addition, these embodiments are able to detect the presence of an actual input data signal with greater robustness and greater resistance to false alarms than single-detector-based sleep recovery circuit designs.

FIG. 2 shows an embodiment of a method of operating the sleep recovery circuit 10 in which the signal detectors 16 of multi-mode detection system 12 are enabled sequentially as the sleep recovery circuit 10 transitions between a sleep mode and a wake mode.

At the beginning of the sleep mode, the detector tracking parameter i is set to 0 and the output data 24 is set consistently with a sleep mode of operating a device incorporating the sleep recovery circuit 10 (step 30). For example, in some implementations, output data 24 corresponding to the input signal 18 may be blocked during the sleep mode. In other implementations, the output data 24 may include a data channel that is set to a predetermined fixed value signaling that the incorporating device should be in a sleep mode of operation. The output data 24 also may include an additional signal channel (e.g., a loss-of-signal (LOS) channel) that is set to a value indicating to the incorporating device that the input signal 18 is not present, or the data quality of the input signal 18 is not sufficient to achieve a specified performance, or that there is some other problem relating to the input signal 18 making it otherwise unavailable.

The signal detection process during the sleep mode proceeds as follows. The detector tracking parameter i is incremented (step 32) and the Signal Detector i is enabled (step 34). If Signal Detector i detects the Signal Characteristic i in the input signal (step 36), the Signal Detector i is disabled (step 38) and the process is repeated for the next signal detector in the sequence 1, . . . , N (steps 32-40) until all of the signal detectors have detected the respective signal characteristics i (i.e., i=N; step 40). If Signal Detector i fails to detect the Signal Characteristic i in the input signal (step 36), the sleep recovery circuit 10 returns to the beginning of the sleep mode (step 30) and repeats the process (steps 32-36) after an optional delay period.

In general, signal detectors 16 are configured to detect respective characteristics of input signal 18 that provide evidence of one or both of the following: (1) input signal 18 is present, and (2) input signal 18 corresponds to a valid input data signal. The number and types of signal characteristics that are detected depend on specifications for the application environment and the device incorporating the sleep recovery circuit 10, including specifications for the characteristics of input signal 18, specifications for the robustness level with which the sleep recovery circuit 10 confirms the presence of input signal 18 before awaking from the sleep mode, and specifications for the target performance level of the incorporating device (e.g., a specified bit error rate (BER)). Among the exemplary signal characteristics that may be detected by signal detectors 16 are direct current (DC) signal characteristics and alternating current (AC) signal characteristics. Examples of DC signal characteristics are a voltage level above a threshold level, and a current level above a threshold level. Examples of AC signal characteristics are an RMS (root mean squared) amplitude above a threshold level, a peak signal level above a threshold level, a frequency within a specified frequency band, and a pulse-width value within a specified range, and a characteristic data pattern (e.g., an initialization pattern or an auto-negotiation pattern) carried by the input signal. The frequency characteristic of an AC input signal 18 may be determined by a standard phase locked loop (PLL) and the pulse-width characteristic of an AC input signal 18 may be determined by a standard pulse-width-comparator-based pulse-width measurement circuit.

In the embodiment of FIG. 2, the signal detectors 16 are enabled one at a time to reduce power consumption in the sleep recovery circuit 10. In some implementations, the signal detectors 16 are enabled in a sequence that minimizes the overall power consumption in the sleep recovery circuit 10. In some implementations, the signal detectors 16 are enabled in the order of lowest power consumption to highest power consumption. The particular order in which the signal detectors 16 are enabled may depend on the number and types of signal detectors in the multi-mode detection system 10. For example, the order in which the signal detectors 16 may be selected based on the rates at which the various signal detectors are able to reject false alarms, such as nonconforming input signals and noise, to achieve a high overall early rejection rate. Such false alarm rejection rates may be determined empirically.

After all of the signal detectors 16 have detected the respective Signal Characteristics i (i.e., i=N; step 40), the sleep recovery circuit 10 enters the wake mode in which the output data 24 is set consistently with a wake mode of operating the device incorporating the sleep recovery circuit 10 (step 42). For example, in some implementations, the output data 24 may include a data channel that passes a signal corresponding to the input data signal 18 through to the incorporating device. The output data 24 also may include an additional signal channel (e.g., a LOS channel) that is set to a value indicating to the incorporating device that the input signal 18 is present and (optionally) is of sufficient quality to achieve a specified performance level.

In the wake mode, the sleep recovery circuit 10 periodically detects at least one characteristic of the input signal to verify that the input signal 18 is present (step 44). In the embodiment illustrated in FIG. 2, the sleep recovery circuit 10 uses signal detector N to verify the presence of input signal 18. In some implementations, signal detector N is configured to detect an AC characteristic of input signal 18. For example, in these implementations, signal detector N may correspond to a standard LOS AC detector that detects when input signal level drops below the threshold at which a specified bit error rate (e.g., 1 in 1000) is predicted. If the input signal 18 is not detected (e.g., because of a system shutdown, a system error, or a data transmission problem; step 44), the sleep recovery circuit 10 returns to the sleep mode (step 30).

In some other implementations, the input signal detection step (step 44) may be repeated, or one or more additional input signal verification steps may be performed, before the sleep recovery circuit 10 transitions from the wake mode back to the sleep mode.

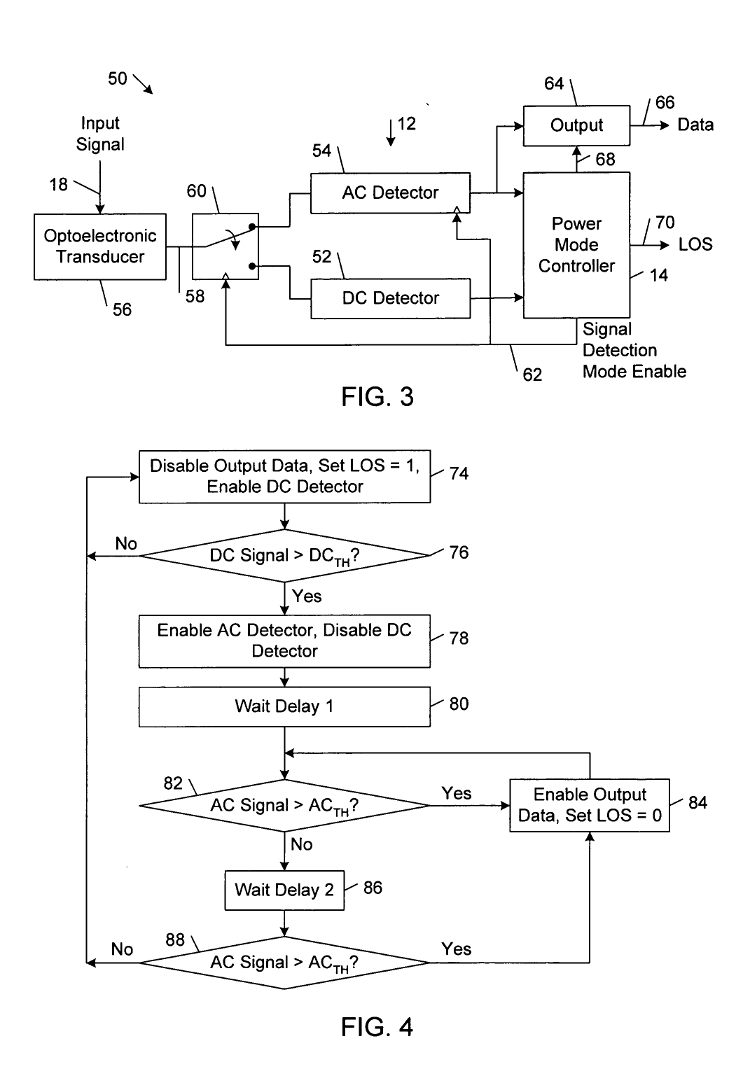

FIG. 3 shows an implementation 50 of the sleep recovery circuit 10 that is suitable for optoelectronic applications. In this implementation, the multi-mode detection system 12 includes a DC detector 52 and an AC detector 54. An optoelectronic transducer 56 (e.g., a photodiode) converts an optical input signal 18 into an electric current input signal 58 that is transmitted to a switch 60. Power mode controller 14 controls switch signal 60 and selectively enables AC detector 54 with a signal detection mode enable signal 62. Power mode controller 14 also uses an output mode enable signal 68 to control the data 66 transmitted by an output 64, which may be implemented by a standard output buffer circuit.

In addition, power mode controller 14 transmits a LOS signal 70 based on the operation mode of the sleep recovery circuit.

DC detector 52 may be any type of detector that detects a DC signal characteristic of electric signal 58 and AC detector 54 may be any type of detector that detects an AC signal characteristic of electric signal 58. In one exemplary embodiment that is suitable for high-frequency fiber optic transceiver applications, DC detector 52 is a DC current threshold detector and AC detector 54 is an AC peak detector. In some implementations, the DC detector 52 and the AC detector 54 may include additional, non-detection-related components. For example, in some implementations, the AC detector 54 may include a front-end transimpedance amplifier for converting the current signal 58 into a voltage signal and amplifying the result.

FIG. 4 shows an embodiment of a method of operating the implementation 50 of the sleep recovery circuit 10. At the beginning of the sleep mode, power mode controller disables output 64, sets the LOS signal 70 to the true state (e.g., a value of “1”) to indicate that the input signal 18 is not present, and enables the DC detector 52 (step 74). In the implementation shown in FIG. 3, the DC detector 52 is enabled by controlling the switch 60 to connect the electric current signal 58 to the input of DC detector 52. If the DC signal characteristic is greater than a specified threshold value (DC_{TH}) (step 76), the power mode controller 14 enables the AC detector 54 and disables the DC detector 52 (step 78). In the implementation shown in FIG. 3, the DC detector 52 is disabled by controlling the switch 60 to connect the electric current signal 58 to the input of AC detector 54, and the AC detector 54 is enabled with signal detection mode enable signal 62. If the DC signal characteristic is not greater than the specified threshold value (DC_{TH}) (step 76), the power mode controller 14 returns to the beginning of the sleep operation mode (step 74) and repeats the DC signal characteristic detection process (step 76) after an optional delay period.

After the AC detector 54 has been enabled (step 78), power mode controller 14 pauses for a delay period before proceeding (step 80). The delay period may, for example, correspond to a time needed for the AC detector 54 to transition from an off-state to a ready-state. After the delay period (step 80), if the AC signal characteristic is greater than a specified threshold value (ACTH) (step 82), the power mode controller 14 enables the output 64 and sets the LOS signal 70 to the false state (e.g., a value of “0”) to indicate that the input signal is present (step 84). If the AC signal characteristic is not greater than the specified threshold value (AC_{TH}) (step 82), the power mode controller 14 pauses for a delay period (step 86) before proceeding to re-check whether or not the AC signal characteristic is greater than the specified threshold value (ACTH) (step 88).

Upon re-checking, if the AC signal characteristic is greater than a specified threshold value (AC_{TH}) (step 88), the power mode controller 14 enables the output 64 and sets the LOS signal 70 to the false state (e.g., a value of “0”) to indicate that the input signal is present (step 84). Otherwise, the power mode controller 14 returns to the beginning of the sleep operation mode (step 74) and repeats the DC signal characteristic detection process (step 76) after an optional delay period.

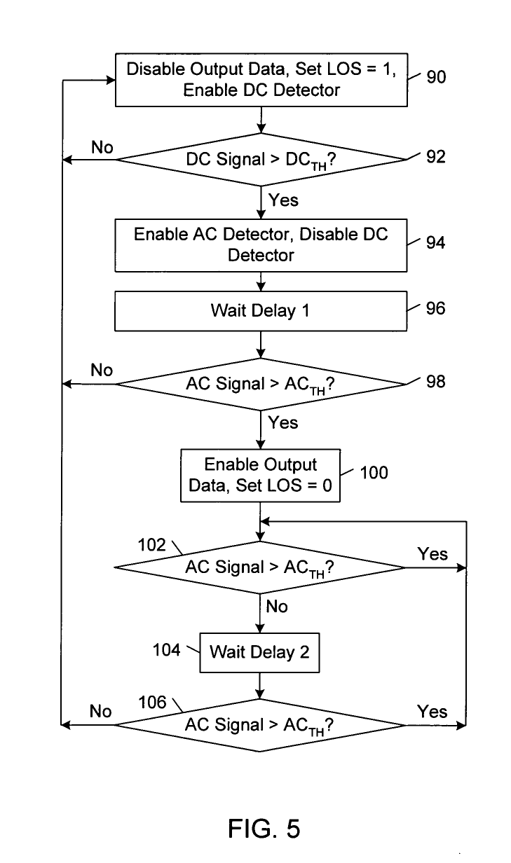

FIG. 5 shows an alternative embodiment of a method of operating the implementation 50 of the sleep recovery circuit 10. At the beginning of the sleep mode, power mode controller disables output 64, sets the LOS signal 70 to the true state (e.g., a value of “1”) to indicate that the input signal 18 is not present, and enables the DC detector 52 (step 90). In the implementation shown in FIG. 3, the DC detector 52 is enabled by controlling the switch 60 to connect the electric current signal 58 to the input of DC detector 52. If the DC signal characteristic is greater than a specified threshold value (DC_{TH}) (step 92), the power mode controller 14 enables the AC detector 54 and disables the DC detector 52 (step 94). In the implementation shown in FIG. 3, the DC detector 52 is disabled by controlling the switch 60 to connect the electric current signal 58 to the input of AC detector 54, and the AC detector 54 is enabled with signal detection mode enable signal 62. If the DC signal characteristic is not greater than the specified threshold value (DC_{TH}) (step 92), the power mode controller 14 returns to the beginning of the sleep operation mode (step 90) and repeats the DC signal characteristic detection process (step 92) after an optional delay period.

After the AC detector 54 has been enabled (step 94), power mode controller 14 pauses for a delay period before proceeding (step 96). The delay period may, for example, correspond to a time needed for the AC detector 54 to transition from an off-state to a ready-state. After the delay period (step 96), if the AC signal characteristic is greater than a specified threshold value (AC_{TH}) (step 98), the power mode controller 14 enables the output 64 and sets the LOS signal 70 to the false state (e.g., a value of “0”) to indicate that the input signal is present (step 100). If the AC signal characteristic is not greater than the specified threshold value (AC_{TH}) (step 98), the power mode controller 14 returns to the beginning of the sleep operation mode (step 90) and repeats the DC signal characteristic detection process (step 92) after an optional delay period.

During the wake mode (steps 102-106), power mode controller 14 checks whether or not the AC signal characteristic is greater than the specified threshold value (AC_{TH}) (step 102). If the AC signal characteristic is not greater than the specified threshold value (AC_{TH}) (step 102), the power mode controller 14 pauses for a delay period (step 104) before proceeding to re-check whether or not the AC signal characteristic is greater than the specified threshold value (AC_{TH}) (step 106). Upon re-checking, if the AC signal characteristic is greater than a specified threshold value (AC_{TH}) (step 106), the power mode controller 14 remains in the wake mode (i.e., the output 64 is enabled and the LOS signal 70 is set to the false state) and the checking, waiting, and re-checking steps are repeated (steps 102-106). Otherwise, the power mode controller 14 returns to the beginning of the sleep mode (step 90) and repeats the DC signal characteristic detection process (step 92) after an optional delay period.

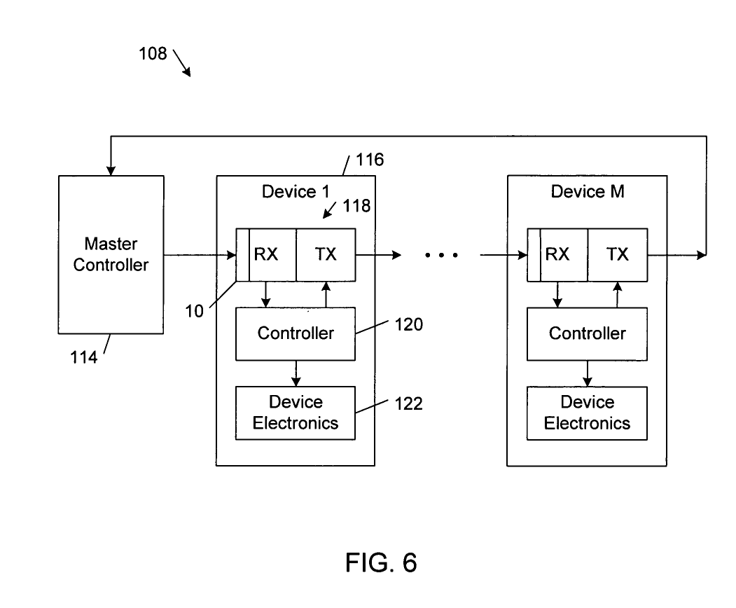

FIG. 6 shows an exemplary application environment 108 in which one or more implementations of sleep recovery circuit 10 may be incorporated. For example, application environment 108 may correspond to a fiber-optic-networked multimedia system that may be configured for deployment in an automotive application environment. Application environment 108 includes a master controller 114 and a series of M devices 116, where M has an integer value of one or more. In an exemplary automotive application environment, the devices 116 may be selected from: a CD changer, active speakers, an integrated cellular telephone, a digital radio, a laptop computer, a CD player, a DVD player, an amplifier, a microphone, a GPS navigation system, a video camera, a video display, and an interactive security system. Each device 116 includes a transceiver module 118, which includes a receiver (RX) and a transmitter (TX), a controller 120, and various device electronics 122.

In application environment 108, the sleep recovery circuits 10 that are embedded in the transceiver modules 118 independently control the operational modes of the respective devices 116 based on the input signals received from upstream components (i.e., either the master controller 114 or one of the devices 116). In this way, downstream devices may remain in the sleep mode if an upstream device determines that a received signal is not an actual data signal. Because the sleep recovery circuits 10 detect multiple characteristics of the input signals before transitioning from the sleep mode to the wake mode, there is a greater likelihood that false alarms will be avoided. Therefore, unnecessary power consumption that otherwise might be caused by inadvertent activation of devices 116 (e.g., by intrusion of stray light into the fiber optic network during system maintenance) may be avoided.

Other embodiments are within the scope of the claims.

1. A device, comprising:
a sleep recovery circuit operable to transition from a first signal detection mode to a second signal detection mode in response to detection of a first signal characteristic in an input signal, and to transition from the second signal detection mode to a third operational mode in response to detection in the input signal of a second signal characteristic different from the first signal characteristic.

2. The device of claim 1, wherein power consumption by the sleep recovery circuit in the first signal detection mode is less than power consumption by the sleep recovery circuit in the second signal detection mode.

3. The device of claim 2, wherein the third operational mode corresponds to a full-power mode of operating the device

4. The device of claim 2, wherein the third operational mode corresponds to a third signal detection mode, and the sleep recovery circuit is operable to transition from the third signal detection mode to a fourth operational mode in response to detection in the input signal of a third signal characteristic different from the first and second signal characteristics.

5. The device of claim 1, wherein the sleep recovery circuit comprises a first signal detector operable to detect the first signal characteristic in the input signal, and a second signal detector operable to detect the second signal characteristic in the input signal.

6. The device of claim 5, wherein only one of the first and second signal detectors is enabled at a time.

7. The device of claim 6, wherein the first signal detector is enabled and the second signal detector is disabled during the first signal detection mode.

8. The device of claim 6, wherein the second signal detector is enabled and the first signal detector is disabled during the second signal detection mode.

9. The device of claim 2, wherein the first signal detector detects a direct current characteristic of the input signal.

10. The device of claim 9, wherein the second signal detector detects an alternating current characteristic of the input signal.

11. The device of claim 9, wherein the second signal detector detects at least one of a frequency characteristic of the input signal and a pulse-width characteristic of the input signal.

12. The device of claim 1, wherein the sleep recovery circuit transmits output data consistent with a sleep mode of operating the device during the first and second signal detection modes.

13. The device of claim 12, wherein the sleep recovery circuit transmits output data comprising a loss-of-signal output set to a true state during the first and second signal detection modes.

14. The device of claim 12, wherein the sleep recovery circuit blocks transmission of output data corresponding to data of the input signal during the first and second signal detection modes.

15. The device of claim 1, wherein the sleep recovery circuit transmits output data corresponding to data of the input signal during the third mode of operating the device.

16. The device of claim 16, wherein the sleep recovery circuit transmits output data comprising a loss-of-signal output set to a false state during the third mode of operating the device.

17. The device of claim 1, wherein the input signal is an optical signal.

18. A method of operating a device, comprising:
detecting a first signal characteristic in an input signal;
transitioning from a first signal detection mode to a second signal detection mode in response to detection of the first signal characteristic in the input signal;
detecting in the input signal a second signal characteristic different from the first signal characteristic;
transitioning from the second signal detection mode to a third operational mode in response to detection of the second signal characteristic in the input signal.

19. The method of claim 18, wherein the steps of detecting the first and second signal characteristics are performed during different respective non-overlapping periods.

20. The method of claim 18, wherein the first signal characteristics is a direct current characteristic of the input signal, and the second signal characteristic is selected from the group consisting of: an alternating current characteristic of the input signal; a phase characteristic of the input signal; and a pulse-width characteristic of the input signal.
